(19) United States
(12) Patent Application Publication
(10) Pub. No.: US 2012/0235530 A1
(43) Pub. Date: Sep. 20, 2012

(54) ELECTRIC MACHINES INCLUDING STATOR MODULES

(75) Inventors: Hector Luis Moya, Austin, TX (US); David Christopher Baker, Austin, TX (US); Ramon Anthony Caamaño, Gilroy, CA (US)

(73) Assignee: GREEN RAY TECHNOLOGIES LLC, Gilroy, CA (US)

(21) Appl. No.: 13/394,951

(22) PCT Filed: Sep. 7, 2010
(86) PCT No.: PCT/US2010/048019

§ 371 Date: May 25, 2012

Related U.S. Application Data
(60) Provisional application No. 61/240,492, filed on Sep. 8, 2009.
(60) Provisional application No. 61/240,501, filed on Sep. 8, 2009.

(51) Int. Cl. H02K 1/27; H02K 1/18

(52) U.S. Cl. 310/156.01; 310/216.008

(57) ABSTRACT

In implementations of the present disclosure, a rotating electric machine includes a rotor assembly supported for rotation about a rotational axis, the rotor assembly including a plurality of rotor poles, the rotor poles being supported for rotation about the rotational axis, and a stator assembly including a plurality of independent stator modules with each stator module including multiple independently energizable stator segments, each stator segment defining a plurality of stator poles of the stator assembly for magnetically interacting with the rotor poles, each stator module being independently removable and replaceable from the stator assembly to adjust the total number of stator poles included in the stator assembly, and/or to vary the maximum power output of the electric machine.

### SUMMARY

In some aspects, the present disclosure provides a rotating electric machine including a rotor assembly supported for rotation about a rotational axis and a stator assembly. The rotor assembly includes a plurality of rotor poles with the rotor poles being supported for rotation about the rotational axis. The stator assembly includes a plurality of independent stator modules with each stator module including multiple independently energizable stator segments. Each stator segment defines a plurality of stator poles of the stator assembly for magnetically interacting with the rotor poles. Each stator module is independently removable and replaceable from the stator assembly to adjust the total number of stator poles included in the stator assembly, and/or to vary the maximum power output of the electric machine.

In some aspects, the number of rotor poles is fixed.

In some aspects, the stator assembly includes a number of receiving arrangements N, each receiving arrangement being capable of receiving a stator module.

In some aspects, the stator assembly includes less than N stator modules and the stator modules are positioned symmetrically around the rotational axis.

In some aspects, the stator assembly includes less than N stator modules and the stator modules are positioned asymmetrically around the rotational axis.

In some aspects, each stator module includes a stator module housing for supporting the multiple stator segments of the stator module in predetermined positions within the stator module housing.

In some aspects, the stator module housing and the stator assembly include an indexing arrangement for controlling the position of the stator module relative to the stator assembly when the stator module is attached to the stator assembly.

In some aspects, each stator module includes a controller for controlling the energizing of the stator segments of that stator module.

In some aspects, the machine further includes a switching arrangement for controlling the stator segments and the switching arrangement is configured such that the switching arrangement is able to cause the stator poles of the stator segments to magnetically interact with the rotor poles at a frequency of at least 400 cycles per second.

In some aspects, the electric machine is a multiple phase electric machine.

In some aspects, each stator module includes at least one stator segment associated with each phase of the electric machine.

In some aspects, the machine is a three-phase machine and each stator module includes at least two stator segments for each phase, the stator module thereby including at least six stator segments.

In some aspects, the stator assembly includes at least six receiving arrangements for receiving up to at least six stator modules.

In some aspects, each stator segment includes a U-shaped magnetic core and each stator segment defines two stator poles located at opposite ends of the U-shaped magnetic core such that the U-shaped magnetic core provides the entire magnetic return path for the two stator poles associated with each stator segment.

In some aspects, the magnetic core of each stator segment is formed from thin film soft magnetic material.

In some aspects, the thin film soft magnetic material is a nano-crystalline material.

In some aspects, the thin film soft magnetic material is an amorphous metal material.

In some aspects, the stator assembly is disposed radially adjacent to the rotor assembly such that the stator assembly and the rotor assembly define therebetween an active magnetic radial gap.

In some aspects, the stator assembly is disposed axially adjacent to the rotor assembly such that the stator assembly and the rotor assembly define therebetween an active magnetic axial gap.

In some aspects, each stator segment is positioned such that the two stator poles of each stator segment are located adjacent to one another and in line with one another along a line that is parallel with the rotational axis of the electric machine. The rotor poles are pairs of rotor poles formed from adjacent pairs of permanent magnet segments configured to form rotor poles of opposite magnetic polarity. Each pair of permanent magnet segments is positioned such that the two permanent magnet segments are located adjacent to one another and in line with one another along a line that is parallel with the rotational axis of the electric machine. With this configuration, the two permanent magnet segments define two adjacent circular paths around the rotational axis of the electric machine when the rotor is rotated about the rotational axis of the electric machine with each of the two adjacent circular paths facing an associated one of the stator poles of each independently energizable stator segment.

In some aspects, the present disclosure provides a stator module for use in a rotating electric machine including a stator assembly having a plurality of stator poles and a rotor assembly supported for rotation relative to the stator assembly about a rotational axis. The rotor assembly includes a plurality of rotor poles for magnetically interacting with the stator poles. The stator module includes multiple independently energizable stator segments with each stator segment defining a plurality of stator poles of the stator assembly. The stator module is configured to be supported in the stator assembly such that the stator module and its associated stator poles are independently removable and replaceable from the stator assembly to adjust the total number of stator poles included in the stator assembly.

In some aspects, the present disclosure provides a stator assembly for an electric machine. The stator assembly includes a plurality of independent stator modules with each stator module including multiple independently energizable stator segments. Each stator segment defines a plurality of stator poles of the stator assembly for magnetically interacting with rotor poles of the electric machine. Each stator module is independently removable and replaceable from the stator assembly to adjust the total number of stator poles included in the stator assembly.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1A is a schematic illustration of an exemplar electric machine including an exemplar stator module in accordance with aspects of the present disclosure.

FIG. 1B is a cross sectional view of the exemplar electric machine of FIG. 1A illustrating an exemplar stator segment and an exemplar stator module housing in accordance with aspects of the present disclosure.

FIG. 1C and FIG. 1D are plan views of an exemplar stator core in accordance with aspects of the present disclosure.

FIG. 2A is a plan view of the exemplar bus bar module of FIG. 1A.

FIG. 2B is a perspective view of the exemplar bus bar module of FIG. 1A.

FIG. 2C is an exploded view of the exemplar bus bar module of FIG. 1A.

FIGS. 3A and 3B illustrate an exemplar bus ring insulator of the exemplar bus bar module of FIGS. 1A to 2C.

FIGS. 4A-4C illustrate an exemplar first bus ring of the exemplar bus bar module of FIGS. 1A to 2C.

FIGS. 5A-5C illustrate an exemplar second bus ring of the exemplar bus bar module of FIGS. 1A to 2C.

FIGS. 6A-6C illustrate an exemplar third bus ring of the exemplar bus bar module of FIGS. 1A to 2C.

FIG. 7 is a schematic illustration of an exemplar electric machine including misaligned phases.

FIG. 8 is a schematic illustration of an exemplar electric machine including a stator assembly phase-shift in accordance with aspects of the present disclosure.

FIG. 9 is a plan view of another exemplar bus bar module including a phase-shift arrangement in accordance with aspects of the present disclosure.

FIG. 10 is an exploded view of the exemplar bus bar module of FIG. 9.

FIGS. 11A-11C illustrate bus rings of the exemplar bus bar module of FIGS. 9 and 10.

FIG. 12 is a schematic illustration of another exemplar electric machine including a stator assembly phase-shift in accordance with aspects of the present disclosure.

FIG. 13 is a schematic illustration of a portion of the exemplar electric machine of FIG. 12 including the exemplar bus bar module of FIGS. 9 and 10.

FIG. 14 is a schematic illustration of an exemplar axial gap version of an electric machine in accordance with aspects of the present disclosure.

Like reference symbols in the various drawings indicate like elements.

### DETAILED DESCRIPTION

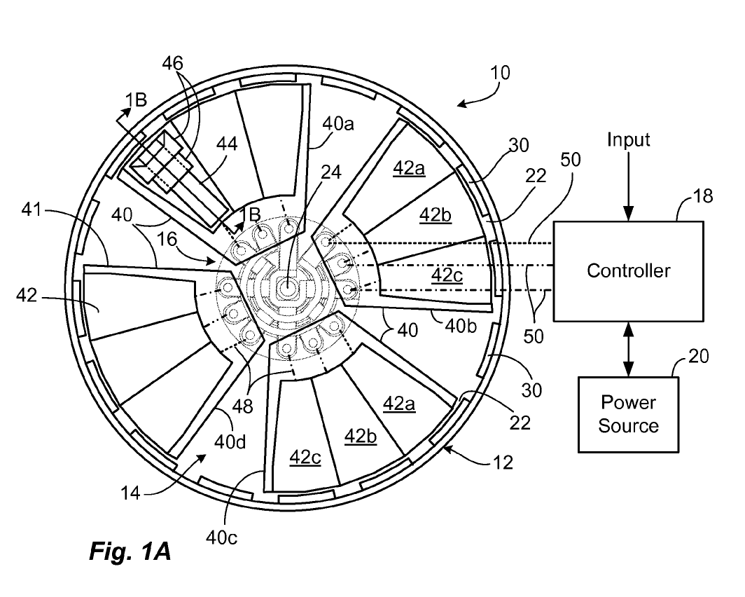

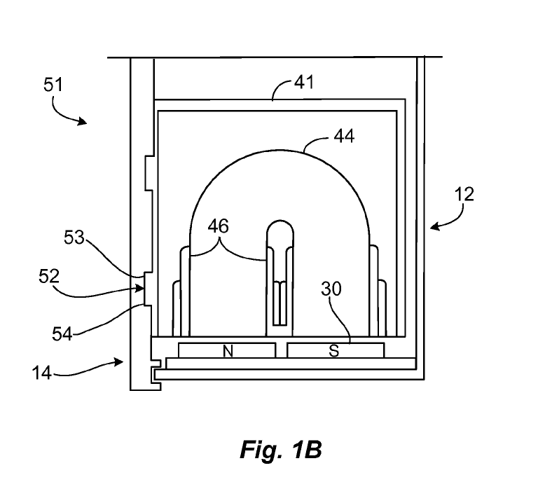

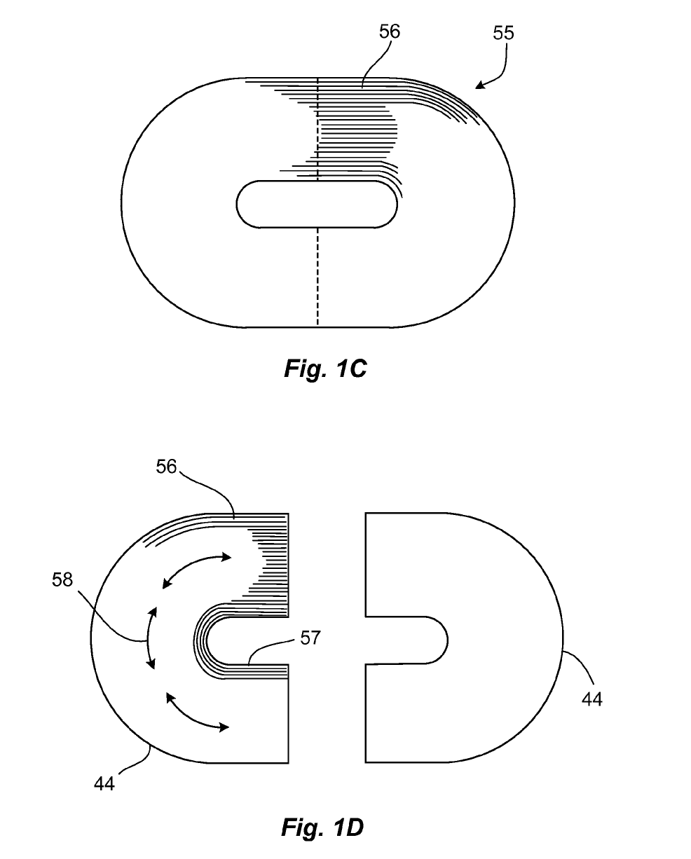

Referring now to FIG. 1A, an exemplar electric machine 10 is illustrated. The electric machine 10 can include, but is not limited to, an electric motor and/or an electric generator. The electric machine 10 includes a rotor assembly 12, a stator assembly 14, a bus bar module 16, and a controller 18. The controller 18 regulates operation of the electric machine 10 based on an input signal and a position signal. The input signal can include a throttle signal, for example, in the case where the electric machine 10 is implemented in a vehicle, motorcycle, scooter, or the like. The electric machine may include a Hall Effect sensor or other position detecting arrangement 19 for detecting the position of the rotor assembly 12 relative to the stator assembly 14. The Hall Effect sensor or other position detecting arrangement 19 may generate the position signal used by the controller. The controller 18 can regulate power provided to the electric machine 10 from a power source 20, when the electric machine 10 is operating in a motor mode. The electric machine 10 can generate power that can be provided to, and stored in the power source 20, when the electric machine 10 is operating in a generator mode.

Although the electric machine 10 can be provided as a DC brushless motor, it is contemplated that the electric machine 10 can be provided as one of a variety of other types of electric machines within the scope of the present disclosure. Such electric machines include, but are not limited to, DC synchronous electric machines, variable reluctance or switched reluctance electric machines, and induction type electric machines. For example, permanent magnets can be implemented as the rotor poles of the electric machine 10, in the case where the electric machine 10 is provided as a DC brushless electric machine, as discussed in further detail below. In the case of a switched reluctance electric machine, or an induction electric machine, the rotor poles can be provided as protrusions of other magnetic materials formed from laminations of materials such as iron or preferably thin film soft magnetic materials, for example. In other arrangements, the rotor poles can be provided as electromagnets.

In the exemplar arrangement of FIG. 1A, the electric machine 10 is provided as a hub-type electric machine with rotor assembly 12 located around the outer perimeter of the electric machine 10. The stator assembly 14 is surrounded by the rotor assembly 12. Although not illustrated in FIG. 1A, the rotor assembly 12 can be supported by bearings to rotate relative to the stator assembly 14. A radial gap 22 separates the rotor assembly 12 from the stator assembly 14. In alternative arrangements, the rotor assembly 12 can be supported for rotation relative to the stator assembly 14 about a rotational axis 24 using other suitable means. Although electric machine 10 is described as a radial gap machine with the stator assembly being surrounded by the rotor assembly, this is not a requirement. Instead, the machine may be a radial gap machine with the stator assembly surrounding the rotor assembly. Alternatively, the rotor assembly and the stator assembly may be axially adjacent to one another forming an axial gap machine.

The rotor assembly 12 includes a plurality of pairs of radially adjacent permanent magnets 30. In some implementations, the pairs of permanent magnets 30 can be provided as super magnets such as cobalt rare earth magnets, or any other suitable or readily providable magnet material. As illustrated best in the cross sectional view of FIG. 1B, each of the pairs of permanent magnets 30 includes a first magnet oriented to form a north rotor pole, and a second magnet oriented to form a south rotor pole. The first magnet is located adjacent to the second magnet such that the two permanent magnets are in line with one another along a line that is generally parallel with the rotational axis 24 of the electric machine 10. Accordingly, the two permanent magnets define adjacent circular paths about the rotational axis 24 of the electric machine 10 when the rotor assembly 12 rotates. As shown in FIG. 1A, the permanent magnet pairs are positioned around the inside periphery of the rotor assembly 12 facing the radial gap 22. Each consecutive pair of permanent magnets 30 is reversed such that all of the adjacent magnet segments alternate from north to south around the entire rotor assembly 12.

Although permanent magnet pairs 30 can be provided as permanent super magnets, other magnetic materials can be implemented. In some implementations, electromagnets can be implemented with the rotor assembly 12 in place of permanent magnets. Also, although the rotor assembly 12 of FIG. 1A is illustrated as including 16 magnet pairs, it is contemplated that the rotor assembly 12 can include any number of magnet pairs.

The stator assembly 14 includes a plurality of stator modules 40. In the exemplar arrangement of FIG. 1A, the stator assembly 14 includes four stator modules 40 which are each identical to one another but are designated by reference numerals 40a, 40b, 40c, and 40d in FIG. 1A for descriptive purpose. Although stator assembly 14 is described as including four stator modules 40, other arrangements are contemplated. For example, stator assemblies including more than four stator modules 40, or less than four stator modules 40 are within the scope of the present disclosure, as discussed in further detail below.

Each stator module 40 is independent from the other stator modules 40 in the stator assembly 14. More specifically, each stator module 40 is independently removable and replaceable. In some implementations, a stator module 40 can be removed, and the electric machine 10 can operate with less than a full complement of stator modules 40. Considering the specific arrangement of FIG. 1A, for example, the electric machine 10 can operate with less than four stator modules 40. That is, the electric machine 10 can operate with one, two, three or four stator modules 40. In addition, if fewer than four stator modules are used in exemplar electric machine 10, the stator modules used may be arranged symmetrically or asymmetrically. For example, if two stator modules are used, stator modules 40a and 40b may be used to form an asymmetrical version of electric machine 10. Alternatively, modules 40a and 40c may be used to form a symmetrical version of electric machine 10.

In the exemplar electric machine 10, each stator module 40 includes a stator module housing 41 and at least one stator segment 42 housed within stator module housing 41. Each stator segment 42 is identical to all of the other stator segments of electric machine 10. In the exemplar arrangement of FIG. 1A, electric machine 10 is provided as a 3-phase electric machine, and each stator module 40 includes three stator segments 42 that are designated by reference numerals 42a, 42b, and 42c respectively in FIG. 1A for descriptive purpose. As will be described in more detail below, the positioning of the three stator segments 42a, 42b, and 42c within stator module housing 41 determines with which phase of the electric machine the stator segment is associated. In exemplar electric machine 10, the first stator segment 42a of each of the stator modules 40 corresponds to a first phase (Phase A) of the electric machine 10. The second stator segment 42b of each of the stator modules 40 corresponds to a second phase (Phase B) of the electric machine 10. The third stator segment 42c of each of the stator modules 40 corresponds to a third phase (Phase C) of the electric machine 10. However, as described above, each stator module 40 of exemplar electric machine 10 is identical to the other stator modules except for its specific location on the stator assembly 14 within the electric machine 10. In addition, each stator segment 42 of each stator module 40 of electric machine 10 is identical to all of the other stator segments except for its location within its stator module 40.

Each stator segment includes a core 44 and windings 46. In an exemplar implementation, the core 44 is a U-shaped magnetic core having windings 46, or coils, wound about each leg of the core 44. Such a stator segment is disclosed in U.S. Pat. Nos. 6,603,237, 6,879,080, 7,030,534, and 7,358,639, the disclosures of which are expressly incorporated herein by reference in their entireties.

In some implementations, the one-piece core can be made from a nano-crystalline, thin film soft magnetic material. In other implementations, any thin film soft magnetic material may be used, and can include, but are not limited to, materials generally referred to as amorphous metals, materials similar in elemental alloy composition to nano-crystalline materials that have been processed in some manner to further reduce the size of the crystalline structure of the material, and any other thin film materials having similar molecular structures to amorphous metal and nano-crystalline materials regardless of the specific processes that have been used to control the size and orientation of the molecular structure of the material.

In other implementations, the core can include a core that is made from a powdered metal. In other implementations, the core can be made from a plurality of stacked laminates. In still other implementations, the core can include a multi-piece core including a plurality of core segments that are assembled and secured together. For example, the core may include a U shaped magnetic core formed from thin film soft magnetic material as described above with core shoes attached to the sides of the U-shaped core at the ends of the legs of the U-shaped core or attached to the ends of the U-shaped core. The shoes may be configured to flare out the ends of the U shaped core to enlarge the surface area of the stator pole face at each end of the U-shaped magnetic core. These shoes can also be formed from thin film soft magnetic material, powdered metal, or any other desired magnetic material.

The vast majority of conventional electric motors are designed to operate at 50 to 60 Hz. The main reason for this is that these are the frequencies available on AC electrical power grids. However, another reason for this, and one of the reasons AC power is typically provided at these frequencies is that these frequencies are well within the frequency capabilities of a conventional iron core motor. Even in the case of specialty iron core motors, the frequencies typically remain below 400 Hz. This is because the iron core material simply cannot respond to the changing magnetic fields this quickly without causing very large losses that show up in the form of heat.

As described above, the exemplar electric machine designed in accordance with the disclosure may use thin film soft magnetic material to form the magnetic core of the stator segments. The use of thin film soft magnetic material for the core material allows for operation at very high frequencies while maintaining high efficiency. These frequencies may be greater than 400 Hz while still providing extremely high efficiencies and may be operated at frequencies as high as or greater than 2500 Hz.

Referring now to FIG. 1C and FIG. 1D, the specific configuration of an exemplar magnetic core 44 for the particular embodiments shown in FIG. 1A and FIG. 1B will be described in more detail. In the illustrated implementations, each individual one-piece magnetic core 44 is formed by winding a continuous ribbon of thin film soft magnetic material into a desired shape. In the case of core 44, the shape is a generally an oval shape as indicated by winding 55 in FIG. 1C. Magnetic cores that are formed using this process of forming a magnetic core by winding many layers of thin film soft magnetic material to form a bulk core is generally referred to as tape wound magnetic cores.

Because thin film soft magnetic materials such as amorphous metal or nano-crystalline materials are typically provided in very thin tape or ribbon form (for example, a few thousandths of an inch or mil thick or even less than 1 mil thick), winding 55 may be made up of hundreds of winds or layers of material as illustrated by lines 56 in FIG. 1C and FIG. 1D. Once wound into the desired shape, winding 55 may be annealed to remove any stresses that may have been caused by the winding process. The winding 55 may be saturated with an adhesive material such as a very thin wicking epoxy that may be heat cured to bind winding 55 into a rigid bulk piece.

Once annealed, thin film soft magnetic materials are very hard and typically very brittle making them somewhat difficult to machine. In the embodiment shown in FIG. 1C and FIG. 1D,winding 55 requires only one cut in order to cut winding 55 into two U-shaped pieces that each provide one of the one-piece magnetic cores 44 described above. As illustrated in FIG. 1D, each of the two U-shaped pieces that result from cutting winding 55 are made up of a plurality of concentric U-shaped layers 57 of thin film soft magnetic material

As described above, one advantage to this configuration is that, when assembled into an electromagnetic assembly as described above, each one-piece magnetic core provides the entire return path for the two stator poles formed by the legs of the U-shaped magnetic core. This eliminates the need for a back iron to magnetically interconnect each of the stator poles.

Another advantage of the above described configuration is that there are no parasitic gaps within the one-piece magnetic cores. That is, each layer of thin film soft magnetic material extends continuously from one end or pole of the U-shaped magnetic core all the way around to the opposite end or pole of the U-shaped magnetic core. Therefore, this configuration orients each of the layers of thin film soft magnetic material in the proper orientation for directing magnetic flux through the magnetic core along the length of each layer of thin film soft magnetic material as illustrated by arrow 58 in FIG. 1D.

The stator segments 42 may be fixed within the stator housing 41 using any suitable and readily providable arrangement for securing stator segments 42 in position within stator housing 41. In an exemplar implementation, an electrically nonconductive and thermally conductive encapsulating material is used to fill the stator housing 41 and to mechanically fix the stator segments 42 in place within the stator housing 41. This encapsulating material may be any suitable and readily providable material including, but not limited to, epoxy mixtures including a variety of fillers such as thermally conductive beads. With this exemplar configuration, the thermally conductive material encapsulating stator segments 42 provides a direct thermal path from the stator segments 42, through the encapsulating material, to the stator housing 41. The stator housing 41 is in direct contact with the wall of the stator assembly 14, which may be exposed to the external environment to dissipate heat away from the stator segments 42. The exterior wall of stator assembly 14 may be provide with fins or other heat dissipating devices such as a liquid cooling system if desired.

When the electric machine 10 is operating in a motor mode, the stator segments 42a, 42b, and 42c of each stator module 40 are selectively energizable by the controller 18 through the bus bar module 16. When the electric machine 10 is operating in a generator mode, energy can be generated by the electromagnetic interaction between the rotor assembly 12 and the stator modules 40, and transferred to the power source 20 through the bus bar module 16. To this end, the bus bar module 16 is in electrical communication with the windings of each of the stator segments 42a, 42b, and 42c through electrical leads 48, each of which corresponds to a phase of the electric machine 10. The electrical leads 48 can be integrated within the stator modules 40, as discussed in further detail below. The bus bar module 16 is also in electrical communication with the controller 18 through electrical leads 50, each of which corresponds to a phase of the electric machine 10.

In the exemplar electric machine 10 illustrated in FIG. 1A and FIG. 1B, the stator assembly 14 includes four stator module receiving arrangements 51. Each receiving arrangement 51 is configured to be capable of receiving one of the stator modules 40. As shown best in FIG. 1B, the stator module receiving arrangements 51 and the associated stator module 40 also include an indexing arrangement 52 for precisely controlling the positioning of the stator module 40 relative to the stator assembly 14 and rotor assembly 12 when the stator module 40 is attached to the stator assembly 14. In the exemplar indexing arrangement 52, each stator housing 41 includes protrusions 53 and each receiving arrangement 51 of the stator assembly 14 includes recesses 54. With this configuration, the protrusions 53 on the stator housings 41 nest into the recesses 54 of their associated receiving arrangements 51 when the stator module 40 is attached to the stator assembly 14 using any suitable and readily providable fasteners or other attaching mechanisms. Although indexing arrangements 52 are described as including the protrusions 53 and recesses 54, any suitable and readily providable indexing arrangement may be used.

As described above, in the exemplar electric machine, each stator module 40 is identical to the other stator modules and each stator segment 42 within each stator module is identical to all of the other stator segments in all of the other stator modules of the electric machine. This modular configuration provides several advantages over prior art electric machines.

First, by using a certain stator segment design for all of the stator segments of a particular electric machine, the magnet core and the windings that are used for the stator segment may be economically produced in mass quantities. In the case of a magnetic core that is formed from thin film soft magnetic material such as those described in the U.S. Patents identified above, this is a very significant advantage because of the problems associated with manufacturing magnetic cores using these types of materials. Electric motors that use magnetic cores formed from thin film soft magnetic material provide significant advantages over conventional iron core electric motors, because thin film soft magnetic material can operate at very high frequencies without incurring high efficiency losses. However, the difficulties associated with manufacturing magnetic cores for electric motors using these low loss materials have prevented these materials from becoming commercially successful in electric motors.

In addition to using the same magnetic core design for all of the stator segments of a particular electric machine, the same magnetic core design may be used for an entire family of electric machines. This may be accomplished by providing a variety of configurations of windings and a variety of stator module housings that are associated with the same magnetic core design. Each electric machine associated with the family of machines would then use a combination of the one magnetic core design, a particular winding configuration, and a particular stator module housing. This further increases the economies of scale associated with producing the particular magnetic core.

In another advantage of the modular design described above, the same electric machine design may be used to provide a variety of electric machines with different power outputs. For example, in the case in which the electric machine is used as a hub motor for an electric scooter application, the same basic motor design may be used to provide an entry level scooter with modest power output, a mid level scooter with moderate power output, and a high end scooter with high power output. In a specific example of this approach, an electric hub motor for a scooter may be designed to include space for up to six stator modules. An entry level scooter may be provided with two stator modules included in the motor, a mid level scooter may be provided with four stator modules included in the motor, and a high end scooter may be provided with six stator modules included in the motor. This approach enables the same basic motor design to be used for all three power levels of scooter, which significantly reduces the costs associated with both developing the scooter design and manufacturing the scooter. This approach also provides the unique ability to upgrade the motor to a higher performance motor later, by adding one or more stator modules.

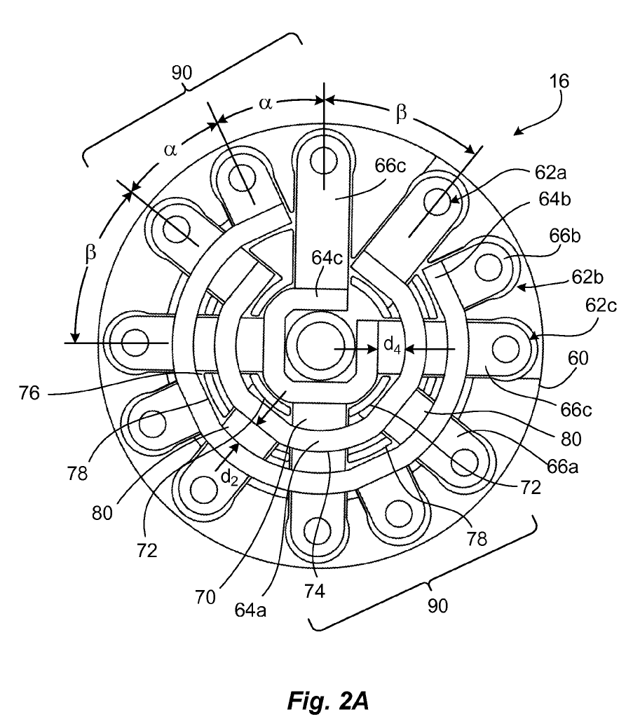

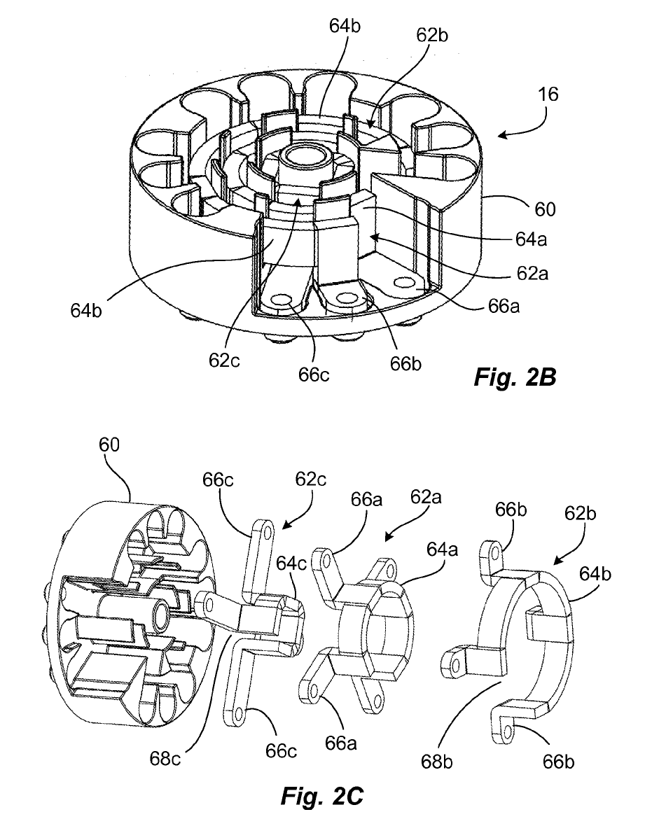

With particular reference to FIGS. 2A-2C, the exemplar bus bar module 16 includes an insulator 60, a bus bar 62a, a bus bar 62b, and a bus bar 62c. Each of the bus bars 62a, 62b, and 62c corresponds to a phase of the electric machine 10. In the exemplar arrangement of FIG. 1A, the bus bar 62a corresponds to the first phase (Phase A), the bus bar 62b corresponds to the second phase (Phase B), and the bus bar 62c corresponds to the third phase (Phase C). The bus bars 62a, 62b, and 62c are concentrically arranged relative to one another, and are nested within the insulator 60, as discussed in further detail below.

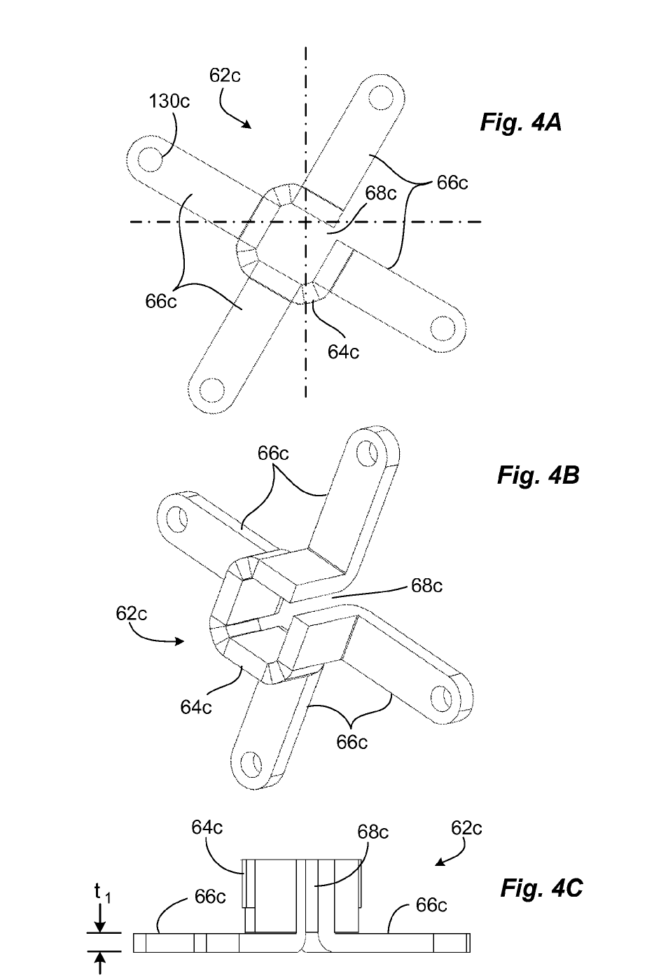

Each of the bus bars 62a, 62b, and 62c includes a generally ring-shaped main body and a plurality of radially extending arms, and provides connecting points for connecting the bus bar to a stator module for electrical communication therebetween. More specifically, the bus bar 62a includes a main body 64a and a plurality of arms 66a, the bus bar 62b includes a main body 64b and a plurality of arms 66b, and the bus bar 62c includes a main body 64c and a plurality of arms 66c. In the exemplar arrangement of FIGS. 1A and 2A-2C, the main body of each bus bar is generally C-shaped having an opening 68a, 68b, and 68c (see FIGS. 4A, 5A and 6A), and each bus bar includes four arms, corresponding to the four stator modules 40 of the exemplar electric machine 10. The bus bars 62a, 62b, and 62c each define at least a portion of an electrical path between the controller 18 and the stator modules 40.

Each of the bus bars 62a, 62b, and 62c is made from an electrically and thermally conductive material (e.g., copper, gold, platinum, electrically conductive non-metallic materials, and/or electrically conductive composite materials). Further, each of the bus bars 62a, 62b, and 62c is exposed, not having an electrically and/or thermally insulating coating provided therearound. In this manner, each bus bar 62a, 62b, and 62c can be manufactured from raw stock of a particular material, without further processing to insulate the bus bar. Each bus bar 62a, 62b, and 62c can be manufactured from a single piece of material, or can be manufactured by assembling multiple components. For example, the main body of a bus bar can be provided as a separate component from the arms, and the arms can be secured to (e.g., through welding) the main body. As another example, a portion of each arm can define a portion of the main body, and the arms can be interconnected by a body component disposed therebetween.

The bus bars 62a and 62c are separated by a radial gap 70 having a distance d₁. The distance d₁ varies about the diameter of the radial gap 70 to provide a plurality of regions 72, in which the distance d₁ is at a minimum (d_{1MIN}), and a plurality of regions 74, in which the distance d₁ is at a maximum (d_{1MAX}). The bus bars 62a and 62b are separated by a radial gap 76 having a distance d₂. The distance d₂ varies about the diameter of the radial gap 76 to provide a plurality of regions 78, in which the distance d₂ is at a minimum (d_{2MIN}), and a plurality of regions 80, in which the distance d₂ is at a maximum (d_{2MAX}).

The bus bars 62a, 62b, and 62c are assembled into the insulator 60, discussed in further detail below. The bus bar 62c is initially assembled into the insulator 60, and the bus bar 62b is subsequently assembled into the insulator 60 to be concentric with the bus bar 62c. The arms 66b and 66c of the bus bars 62b and 62c lie in a common plane, and the arms 66c of the bus bar 62c extend below the main body 64b of the bus bar 62b. In this manner, the bus bar 62c can be said to be nested within the bus bar 62b. The bus bar 62a is subsequently assembled into the insulator 60 to be concentric with the bus bars 62b and 62c. The arms 66a, 66b, and 66c of the bus bars 62a, 62b, and 62c lie in a common plane, and the arms 66b and 66c of the bus bars 62b and 62c extend below the main body 64a of the bus bar 62a. In this manner, the bus bars 62b and 62c can be said to be nested within the bus bar 62a.

The arms 66a, 66b, and 66c of the bus bars 62a, 62b, and 62c define a plurality of sets of arms 90. In the exemplar arrangement of FIGS. 1A and 2A-2C, four sets of arms 90 are provided, corresponding to the four stator modules 40 of the electric machine 10, and each set of arms 90 includes three arms 66a, 66b, and 66c, corresponding to the exemplar phases of the electric machine 10. Adjacent arms 62a and 62b, and 62b and 62c in a set of arms 90 define a first angle α. The sets of the plurality of sets of arms 90 are offset from one another by a second angle β, which is different than (i.e., not equal to) the first angle α. In the illustrated arrangement, α is greater than β. However, other arrangements are contemplated, in which α is less than β. Because α and β are not equal, improper connection of the stator modules 40 to the bus bar module 16 is prohibited, as discussed in further detail herein.

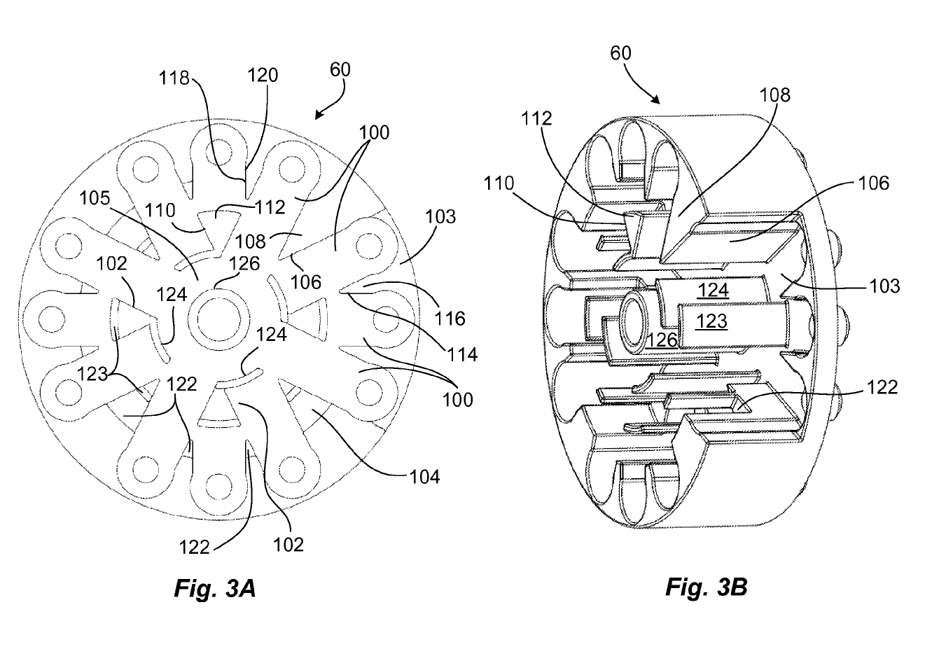

Referring now to FIGS. 3A and 3B, the insulator 60 includes a plurality of radially extending grooves 100, and a plurality of diametric grooves 102, 104, and 105 crossing the radial grooves 100. The radial grooves receive and accommodate the arms 66a, 66b, and 66c of the bus bars 62a, 62b, and 62c, and the diametric grooves 102, 104, and 105 receive and accommodate the main bodies 64a, 64b, and 64c of the bus bars 62a, 62b, and 62c, respectively. The insulator 60 also includes a wedge-shaped recess 103 extending to the periphery of the insulator 60. The recess 103 provides space for and accommodates the interconnection of the bus bars 62a, 62b, and 62c to electrical leads (e.g., electrical leads 50) for connecting the bus bar module 16 to the controller 18.

The diametric groove 102 includes a stop 106 defined by a geometric feature 108 of the insulator 60, and a stop 110 defined by a geometric feature 112 of the insulator 60. The stops 106, 110 provide for indexing of the bus bar 62a as it is assembled into the diametric groove 102. More specifically, the geometric features 108 and 110 extend into the opening 68a of the bus bar 62a to ensure that the bus bar 62a is properly assembled into the insulator 60. The diametric groove 102 further includes a plurality of lands 112 that can support the bus bar 62a. The diametric groove 104 includes a stop 114 defined by a geometric feature 116 of the insulator 60, and a stop 118 defined by a geometric feature 120 of the insulator 60. The stops 114 and 118 provide for indexing of the bus bar 62b as it is assembled into the diametric groove 104. More specifically, the geometric features 116 and 120 extend into the opening 68b of the bus bar 62b to ensure that the bus bar 62b is properly assembled into the insulator 60. The diametric groove 104 further includes a plurality of lands 122 that can support the bus bar 62b.

The insulator 60 further includes a first plurality of diametric walls 123 provided between the diametric groove 102 and the diametric groove 104, and a second plurality of diametric walls 124 provided between the diametric grooves 102 and 103. A cylindrical wall 126 is provided at the center of the insulator 60. Each of the first plurality of walls 123 and each of the second plurality of walls 124 is discontinuous along respective diameters. In this manner, each of the walls 123 and 124 of the plurality of walls is provided as a wall segment.

The insulator 60 is made from an electrically non-conductive material. Exemplar materials include, but are not limited to, plastics, thermoplastics, rubber, and/or electrically non-conductive composite materials. The insulator 60 can be manufactured using various manufacturing methods. Exemplar manufacturing methods include, but are not limited to, stereolithography, injection molding, blow molding, thermoforming, transfer molding, compression molding, and extrusion.

Referring again to FIG. 2A, the walls 123 are disposed between the bus bar 62a and the bus bar 62b in the regions 78. In this manner, the walls 123 inhibit arcing between the bus bar 62a and the bus bar 62b. The walls 124 are disposed between the bus bar 62a and the bus bar 62c in the regions 72. In this manner, the walls 124 inhibit arcing between the bus bar 62a and the bus bar 62c. In the exemplar arrangement of FIG. 2A, no walls are provided between the bus bar 62a and the bus bar 62b in the regions 80, and no walls are provided between the bus bar 62a and the bus bar 62c in the regions 74. In the regions 74 and 80, the radial gaps are of a sufficient distance that arcing is inhibited for the anticipated voltage and current communicated through the bus bars, and insulator walls are not necessary. The absence of insulator walls in these regions enable the bus bars 62a, 62b, and 62c to be assembled into the insulator 60, and reduces the amount of material required to manufacture the insulator 60, thereby also reducing the weight and cost of the insulator 60. The absence of insulator walls in these regions also enables air to flow more freely through the bus bar module 16, thereby extracting heat from the bus bar module 16.

Referring now to FIGS. 4A-4C, and as discussed above, the bus bar 62c includes the main body 64c and the plurality of arms 66c. A bore 130c is provided at the distal end of and through each of the arms 66c. The bore 130c enables a fastener (not shown) to be received for securing the bus bar module 16 within the electric machine, and for providing electrical communication between the bus bar 62c and the stator modules. For example, each fastener can extend into a corresponding opening of the stator modules, and provide at least a portion of an electrical path between the bus bar 62c and the respective stator segments. The arms 66c are generally L-shaped, extend radially outward and include a thickness t₁. The arms 66c are equidistantly spaced from one another in the radial direction by an angle θ. In the exemplar arrangement provided herein, 0 is equal to 90°.

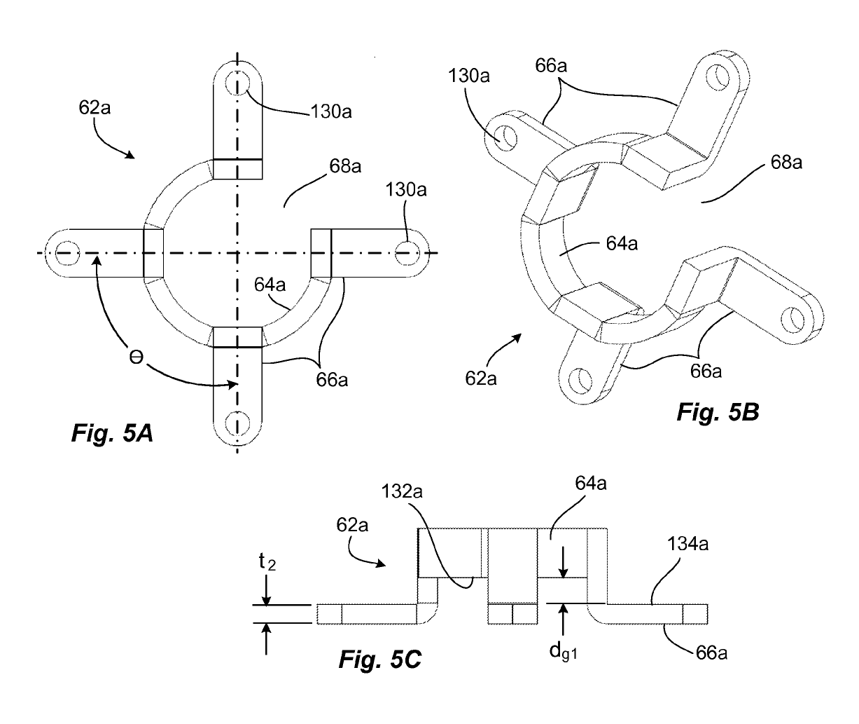

Referring now to FIGS. 5A-5C, and as discussed above, the bus bar 62a includes the main body 64a and the plurality of arms 66a. A bore 130a is provided at the distal end of and through each of the arms 66a. The bore 130a enables a fastener (not shown) to be received for securing the bus bar module 16 within the electric machine, and for providing electrical communication between the bus bar 62a and the stator modules. For example, each fastener can extend into a corresponding opening of the stator modules, and provide at least a portion of an electrical path between the bus bar 62a and the respective stator segments. The arms 66a are generally L-shaped, extend radially outward, and include a thickness t₂. In one arrangement, t₁ is equal to t₂. A base of the main body 132a is offset from a top plane 134a of the arms 66a by a distance d_{g1}. In this manner, the distance d_{g1} defines a gap between the main body 64a of the bus bar and the nested arms 66c of the bus bar 62c extending thereunder. The distance d_{g1} is sufficient to inhibit arcing between the bus bar 62a and the bus bar 62c. The arms 66a are equidistantly spaced from one another in the radial direction by an angle θ. In the exemplar arrangement provided herein, θ is equal to 90°.

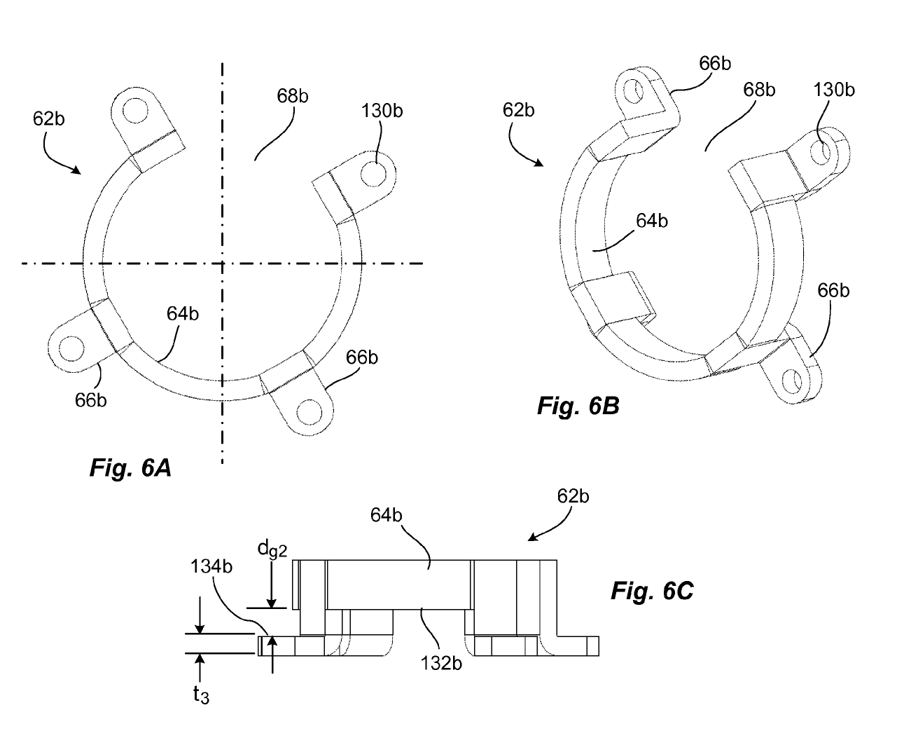

Referring now to FIGS. 6A-6C, and as discussed above, the bus bar 62b includes the main body 64b and the plurality of arms 66b. A bore 130b is provided at the distal end of and through each of the arms 66b. The bore 130b enables a fastener (not shown) to be received for securing the bus bar module 16 within the electric machine, and for providing electrical communication between the bus bar 62b and the stator modules. For example, each fastener can extend into a corresponding opening of the stator modules, and provide at least a portion of an electrical path between the bus bar 62b and the respective stator segments. The arms 66b are generally L-shaped, extend radially outward, and include a thickness t₃. In one arrangement, t₁, t₂, and t₃ are equal. A base 132b of the main body 64b is offset from a top plane 134b of the arms 66b by a distance d_{g2}. In this manner, the distance d_{g2} defines a gap between the main body 64b of the bus bar and the nested arms 66a and 66c of the bus bars 62a and 62c extending thereunder. The distance d_{g2} is sufficient to inhibit arcing between the bus bar 62b and the bus bars 62a and 62c. The arms 66b are equidistantly spaced from one another in the radial direction by an angle θ. In the exemplar arrangement provided herein, θ is equal to 90°.

Referring again to FIG. 1A, the exemplar electric machine 10 includes a stator segment to magnet ratio that enables the same stator segment 42a, 42b, and 42c of each stator module 40 to appropriately align with the rotor assembly 12. More specifically, when a stator segment 42a, 42b, and 42c of a particular stator module 40 is properly aligned with the rotor assembly 12 for the currently charged phase, the corresponding stator segment 42a, 42b, and 42c of the remaining stator modules 40 are also properly aligned with the rotor assembly 12. In FIG. 1A, for example, the stator segments 42c of each of the stator modules 40 are all properly aligned with the magnets of the rotor assembly 12 for the illustrated rotor assembly position relative to the stator assembly 14.

During operation in a motor mode, power is provided to the stator segments 42a, 42b, and 42c with the stator modules 40 through the bus bar module 16. As the electric machine 10 operates, heat is generated within the stator modules 40, which heat reduces operating efficiency. The bus bars 62a, 62b, and 62c function as a heat sink to draw heat from the stator module 40, thereby increasing the operating efficiency of the electric machine. More specifically, the thermally conductive bus bars 62a, 62b, and 62c are in heat transfer communication with the stator segments 42a, 42b, and 42c through the fasteners, for example. As discussed above, the bus bars 62a, 62b, and 62c are exposed and do not include a thermally insulating coating. In this manner, heat can dissipate to the air surrounding the bus bars 62a, 62b, and 62c. As also discussed above, air is free to flow through the radial and diametric grooves of the insulator 60. In this manner, the heat dissipation of the bus bars 62a, 62b, and 62c can be improved.

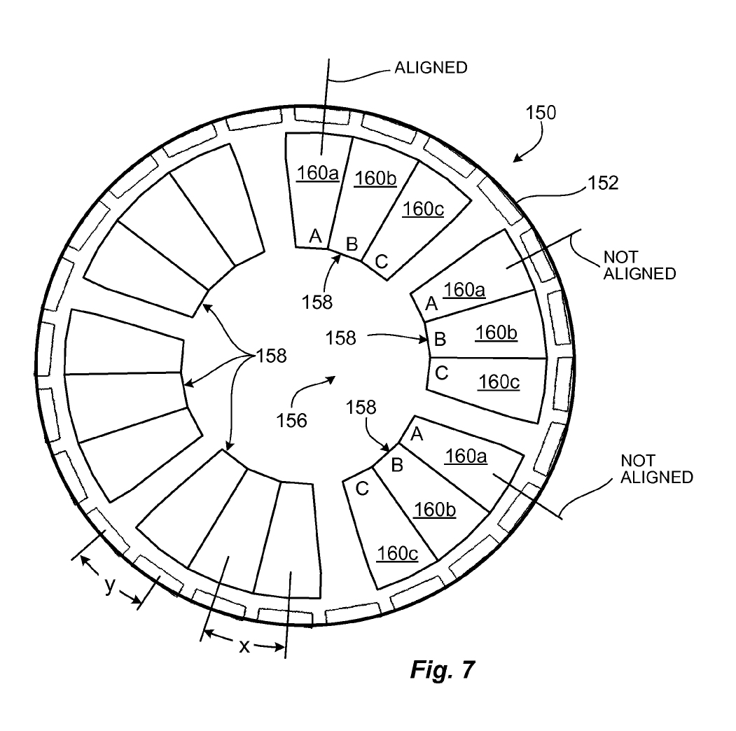

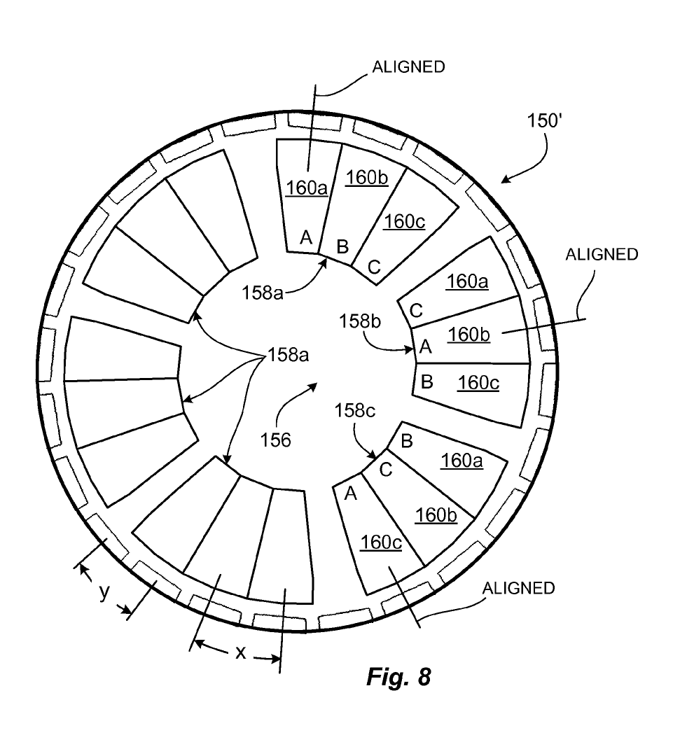

Efforts to optimize the stator segment to magnet ratio to maximize the winding density within the stator assembly 14 can result in difficulty in aligning the stator segments and rotor assembly for the individually charged phase. With particular reference to FIG. 7, an exemplar electric machine 150 is illustrated and includes misaligned stator segments with respect to a rotor assembly 152. More specifically, the electric machine 150 includes the rotor assembly 152, a stator assembly 156 having a plurality of identical stator modules 158. Each of the stator modules 158 includes a plurality of stator segments 160a, 160b, and 160c. As illustrated in FIG. 7 (as well as FIG. 8), a stator segment spacing X and a rotor pole spacing Y are provided. The stator segment spacing X is provided as the center-to-center distance between adjacent stator segments within a stator module. The rotor pole spacing Y is provided as the center-to-center distance between adjacent rotor poles. The stator segment distance X is greater than the rotor pole spacing Y.

With the given rotor position of FIG. 7, a common stator segment is not properly aligned with a respective magnet pair. Consequently, proper operation of the electric machine 150 is inhibited. More specifically, although the stator segment 160a, in a first position of the uppermost stator module 158 (the stator module 158 at approximately the 1 o'clock position), is properly aligned with its respective magnet pair, the same stator segments 160a, in the first position of other stator modules 158 (e.g., the stator modules 158 at approximately the 3 o'clock and 5 o'clock positions), are out of proper alignment with the respective magnet pairs. In order for the stator segments of the stator modules to properly align, the stator modules would be required to be custom made for a particular radial position within the electric machine. Consequently, identical stator modules could not be implemented, increasing cost and complexity of the electric machine.

Referring now to FIG. 8, the present disclosure provides a phase-shift arrangement, in which identical stator modules can be implemented in the stator assembly. More specifically, FIG. 8 illustrates the electric machine 150′ including the rotor assembly 152, and the stator assembly 156. The stator assembly 156 includes a plurality of identical stator modules 158a, 158b, and 158c. The stator modules 158a, 158b, and 158c are identical and can be interchanged with one another, or replaced, without adversely affecting operation of the electric machine 150′. Each of the stator modules 158 includes a plurality of stator segments 160a, 160b, and 160c.

In accordance with the phase-shift arrangement of the present disclosure, an arbitrary phase relationship for the electrical connections in an N-phase electrical machine is provided. The stator segments 160a, 160b, and 160c are electrically connected to the controller to shift the phases across the stator segments. More specifically, the stator module 158a is electrically connected such that the stator segment 160a, in the first position, corresponds to a first phase (Phase A), the stator segment 160b, in the second position, corresponds to a second phase (Phase B), and the stator segment 160c, in the third position, corresponds to a third phase (Phase C). The stator module 158b, however, is electrically connected such that the stator segment 160a, in the first position, corresponds to the third phase (Phase C), the stator segment 160b, in the second position, corresponds to the first phase (Phase A), and the stator segment 60c, in the third position, corresponds to the second phase (Phase B).

The stator module 158c is electrically connected such that the stator segment 160a, in the first position, corresponds to the second phase (Phase B), the stator segment 160b, in the second position, corresponds to the third phase (Phase C), and the stator segment 160c, in the third position, corresponds to the first phase (Phase A). This shifting pattern is repeated about the remainder of the stator assembly 156. In this manner, the N-phases of the electric machine 150′ (in this case N is equal to 3) are electrically shifted as between adjacent stator modules 158a, 158b, and 158c. Consequently, identical stator modules can be implemented without adversely affecting operation of the electric machine.

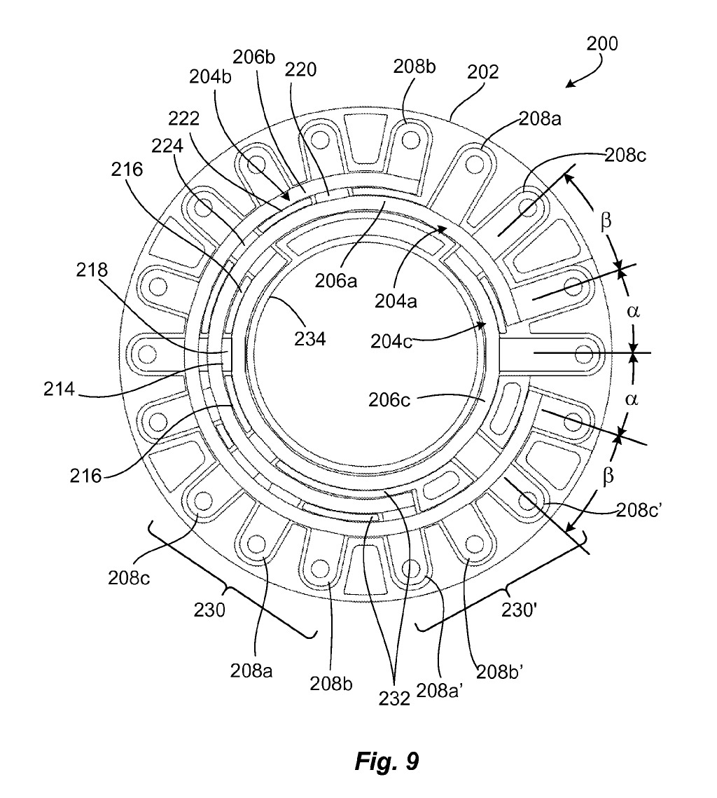

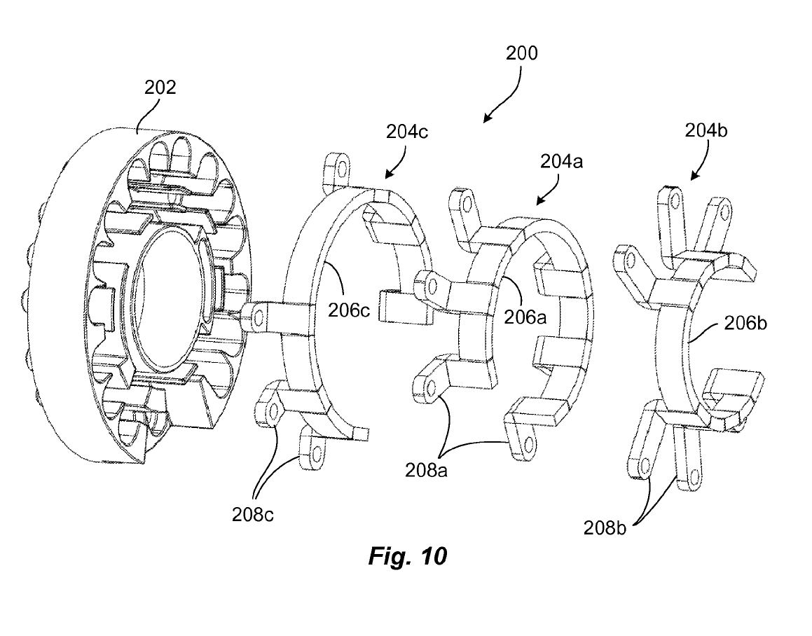

Referring now to FIGS. 9 and 10, a bus bar module 200 is illustrated, which can be implemented to achieve the phase-shift arrangement discussed above. The bus bar module 200 includes an insulator 202, a bus bar 204a, a bus bar 204b, and a bus bar 204c. Each of the bus bars 204a, 204b, and 204c corresponds to a phase of a corresponding electric machine (e.g., electric machine 50 of FIG. 8). In the exemplar arrangement, the bus bar 204b can correspond to a first phase (Phase A), the bus bar 204a can correspond to a second phase (Phase B), and the bus bar 204c can correspond to a third phase (Phase C). The bus bars 204a, 204b, and 204c are concentrically arranged relative to one another, and are nested within the insulator 202.

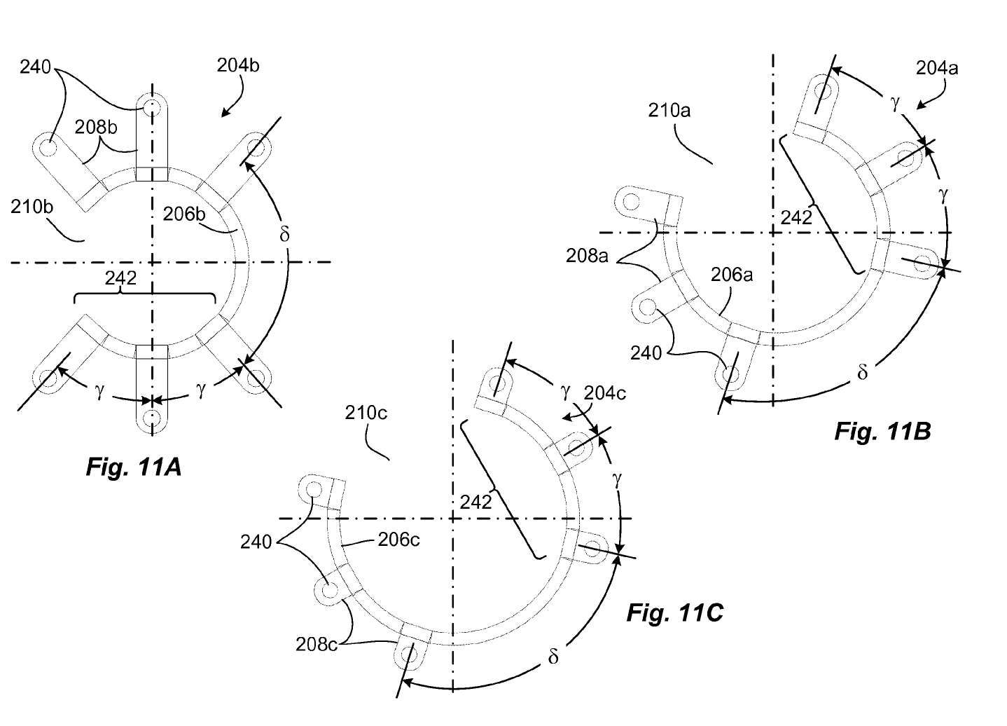

Each of the bus bars 204a, 204b, and 204c includes a generally ring-shaped main body and a plurality of radially extending arms. More specifically, the bus bar 204a includes a main body 206a and a plurality of arms 208a, the bus bar 204b includes a main body 206a and a plurality of arms 208a, and the bus bar 204c includes a main body 206c and a plurality of arms 208c. In the exemplar arrangement of FIGS. 9 and 10, the main body 206a, 206b, and 206c of each bus bar 204a, 204b, and 204c is generally C-shaped having an opening 210a, 210b, and 210c (see FIGS. 11A-11C); and each bus bar 204a, 204b, and 204c includes six arms 208a, 208b, and 208c, corresponding to a potential of six stator modules of an exemplar electric machine. The bus bars 204a, 204b, and 204c each define at least a portion of an electrical path between a controller and the stator modules.

Each of the bus bars 204a, 204b, and 204c is made from an electrically and thermally conductive material (e.g., copper, gold, platinum, electrically conductive non-metallic materials, and/or electrically conductive composite materials). Further, each of the bus bars 204a, 204b, and 204c is exposed, not having an electrically and/or thermally insulating coating provided therearound. In this manner, each bus bar 204a, 204b, and 204c can be manufactured from raw stock of a particular material, without further processing to insulate the bus bar. Each bus bar 204a, 204b, and 204c can be manufactured from a single piece of material, or can be manufactured by assembling multiple components. For example, the main body of a bus bar can be provided as a separate component from the arms, and the arms can be secured (e.g., through welding) to the main body. As another example, a portion of each arm can define a portion of the main body, and the arms can be interconnected by a body component disposed therebetween.

The bus bars 204a and 204c are separated by a radial gap 214 having a distance d₁. The distance d₁ varies about the diameter of the radial gap 214 to provide a plurality of regions 216, in which the distance d₁ is at a minimum (d_{1MIN}), and a plurality of regions 218, in which the distance d₁ is at a maximum (d_{1MAX}). The bus bars 204a and 204b are separated by a radial gap 220 having a distance d₂. The distance d₂ varies about the diameter of the radial gap 220 to provide a plurality of regions 222, in which the distance d₂ is at a minimum (d_{2MIN}), and a plurality of regions 224, in which the distance d₂ is at a maximum (d_{2MAX}).

The bus bars 204a, 204b, and 204c are assembled into the insulator 200, discussed in further detail below. The bus bar 204c is initially assembled into the insulator 200, and the bus bar 204a is subsequently assembled into the insulator 200 to be concentric with the bus bar 204c. The arms 208a and 208c of the bus bars 204a and 204c lie in a common plane, and the arms 208c of the bus bar 204c extend below the main body 206a of the bus bar 204a. In this manner, the bus bar 204c is nested within the bus bar 204a. The bus bar 204b is subsequently assembled into the insulator 200 to be concentric with the bus bars 204a and 204c. The arms 208a, 208b, and 208c of the bus bars 204a, 204b, and 204c lie in a common plane, and the arms 208a, and 208c of the bus bars 204a and 204c extend below the main body 206b of the bus bar 204b. In this manner, the bus bars 204a and 204c are nested within the bus bar 204b.

The arms of the bus bars define a plurality of sets of arms 230. In the exemplar arrangement of FIG. 9, six sets of arms are provided, corresponding to a potential of six stator modules to be included with an associated the electric machine. Each set of arms 230 includes three arms, corresponding to the exemplar phases of the electric machine. Adjacent arms 208a and 208c, and 208b and 208c in a set of arms 230 define a first angle α. The sets of the plurality of sets of arms 230 are offset from one another by a second angle β, which is different than (i.e., not equal to) the first angle α. In the illustrated arrangement, α is less than β. However, other arrangements are contemplated, in which α is greater than β. Because α and β are not equal, improper connection of the stator modules to the bus bar module 200 is prohibited, as discussed herein.

The insulator 202 includes a plurality of radially extending grooves, and a plurality of diametric grooves crossing the radial grooves, as similarly described above with respect to the insulator 202. The radial grooves receive and accommodate the arms 208a, 208b, and 208c of the bus bars 204a, 204b, and 204c, and the diametric grooves receive and accommodate the main bodies 206a, 206b, and 206c of the bus bars 204a, 204b, and 204c. The diametric grooves include stops defined by geometric features of the insulator 202 to provide for indexing of the bus bars 204a, 204b, and 204c as they are assembled into their respective diametric grooves. More specifically, the geometric features extend into the respective openings 210a, 210b, and 210c of the bus bars 204a, 204b, and 204c to ensure that the bus bars 204a, 204b, and 204c are properly assembled into the insulator 202. The diametric grooves can further include lands that can be used to support the bus bars 204a, 204b, and 204c.

The insulator 202 further includes a diametric walls 232 provided between the bus bars 204a, 204b, and 204c. Each of the walls 232 is discontinuous along respective diameters. In this manner, each of the walls 232 is provided as a wall segment. A cylindrical wall 234 is provided at the center of the insulator 202.

The insulator 202 is made from an electrically non-conductive material. Exemplar materials include, but are not limited to, plastics, thermoplastics, rubber, and/or electrically non-conductive composite materials. The insulator 202 can be manufactured using various manufacturing methods. Exemplar manufacturing methods include, but are not limited to, stereolithography, injection molding, blow molding, thermoforming, transfer molding, compression molding, and extrusion.

Referring again to FIG. 9, the walls 232 are disposed between the bus bars 204a, 204b, and 204c along the regions 216 and 222. In this manner, the walls 232 inhibit arcing between the bus bars 204a, 204b, and 204c. In the exemplar arrangement of FIG. 9, no walls are provided between the bus bars 204a, 204b, and 204c in the regions 218 and 224. In the regions 218 and 224, the radial gaps 214 and 220 are of a sufficient distance that arcing is inhibited for the anticipated voltage and current communicated through the bus bars 204a, 204b, and 204c, and insulator walls are not necessary. The absence of insulator walls in these regions enables the bus bars 204a, 204b, and 204c to be assembled into the insulator 202, and reduces the amount of material required to manufacture the insulator 202, thereby also reducing the weight and cost of the insulator 202. The absence of insulator walls in these regions also enables air to flow more freely through the bus bar module 200, thereby extracting heat from the bus bar module, as discussed in further detail below.

Referring now to FIGS. 11A-11C, and as discussed above, each bus bar 204a, 204b, and 204c includes the main body 206a, 206b, and 206c and the plurality of arms 208a, 208b, and 208c. A bore 240 is provided at the distal end of and through each of the arms 208a, 208b, and 208c. The bores 240 enable fasteners (not shown) to be received for securing the bus bar module 200 within an electric machine, and for providing electrical communication between the bus bars 204a, 204b, 204c and respective stator modules. For example, each fastener can extend into a corresponding opening of respective stator modules, and provide at least a portion of an electrical path between the bus bars 204a, 204b, and 204c and the respective stator segments. The arms 208a, 208b, and 208c are generally L-shaped, extend radially outward and include a thickness t_{ARM}. The arms 208a, 208b, and 208c of each of the respective bus bars 204a, 204b, and 204c are provided in sets 242. Adjacent arms in a set 242 are offset from one another by an angle γ. The sets 242 are offset from one another by another angle δ.

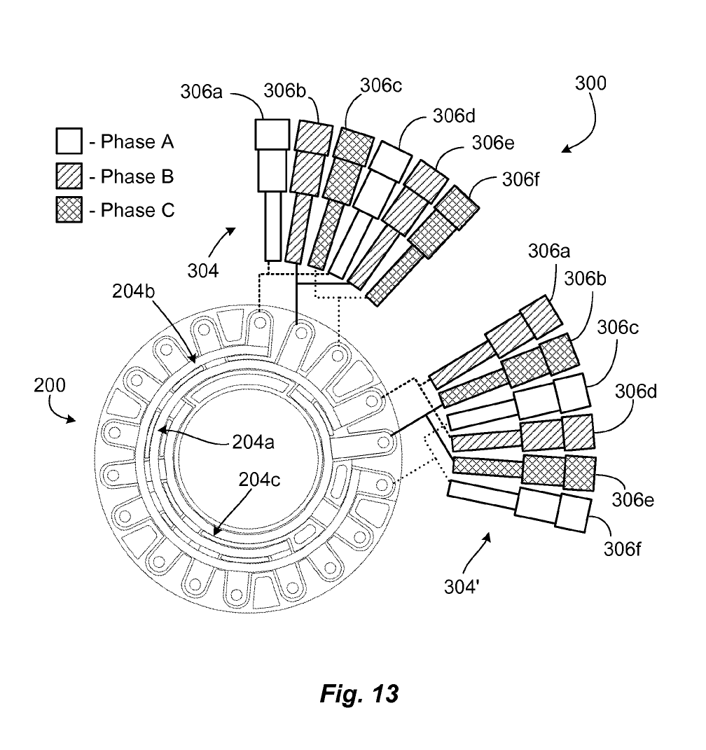

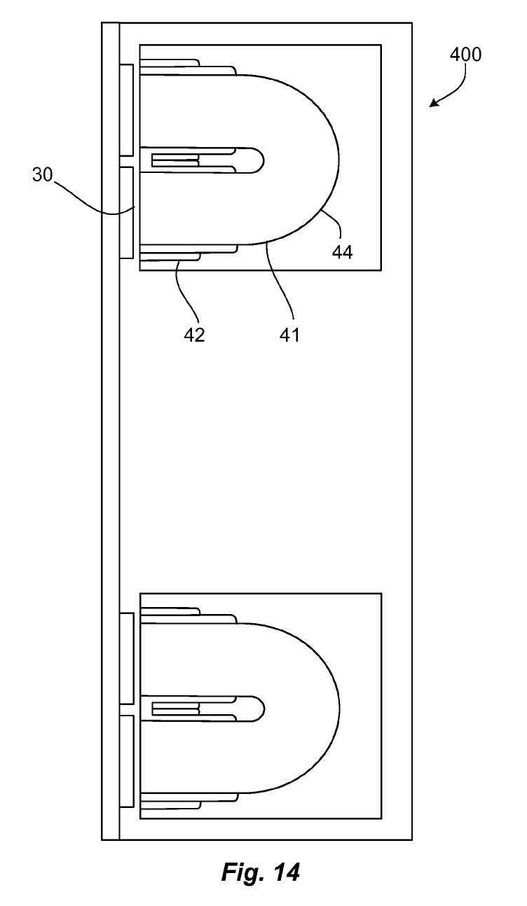

Referring again to FIG. 9, the above-described geometry of the bus bars 204a, 204b, and 204c implicitly provides the phase-shift arrangement discussed above. More specifically, and as highlighted in further detail below with reference to FIG. 13, the arms of a particular bus bar correspond to various radial positions within the sets 230. For example, in one set 230, an arm 208b is in a first position, an arm 208a is in a second position, and an arm 208c is in a third position. In another set 230′, adjacent to the set 230, an arm 208c′ is in the first position, an arm 208b′ is in the second position and an arm 208a′ is in the third position. Accordingly, the arms of the respective bus bars shift positions across respective sets, thereby shifting a corresponding phase from set to set.

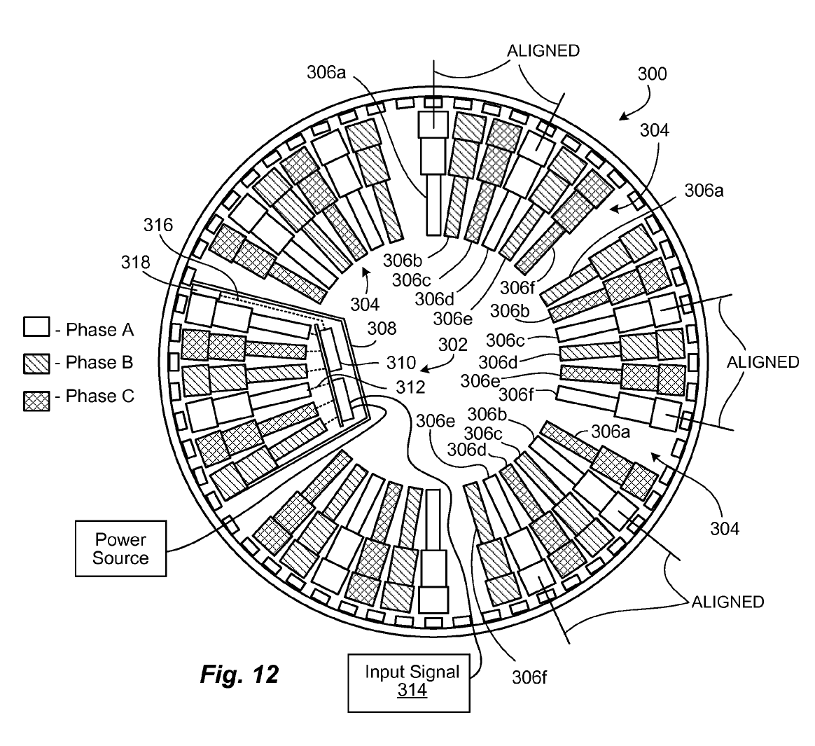

Referring now to FIG. 12, portions of another exemplar electric machine 300 are schematically illustrated. The electric machine 300 includes a stator assembly 302 having a plurality of identical stator modules 304. Each stator module 304 includes a plurality of stator segments 306a, 306b, 306c, 306d, 306e, and 306f. The stator segments 306a, 306b, 306c, 306d, 306e, and 306f correspond to particular phases of the electric machine, and are provided in sets including a plurality of stator segments corresponding to a common phase.

In the exemplar arrangement of FIG. 12, each set includes two stator segments separated from each other by intermediate stator segments. For example, and with respect to the upper-most stator module 304 (e.g., at approximately the 1 o'clock position), one set includes stator segments 306a and 306d corresponding to a first phase (Phase A), another set includes stator segments 306b and 306e corresponding to a second phase (Phase B), and still another set includes stator segments 306c and 306f corresponding to a third phase (Phase C). With respect to the right-most stator module 304 (e.g., at approximately the 3 o'clock position), the set of stator segments 306a and 306d corresponds to the second phase (Phase B), set of stator segments 306b and 306e corresponds to the third phase (Phase C), and the set of stator segments 306c and 306f corresponds to the first phase (Phase A). With respect to the lower right stator module 304 (e.g., at approximately the 5 o'clock position), the set of stator segments 306a and 306d corresponds to the third phase (Phase C), set of stator segments 306b and 306e corresponds to the first phase (Phase A), and the set of stator segments 306c and 306f corresponds to the second phase (Phase B).

In this manner, the phases are shifted by one stator segment as between adjacent, identical stator modules 304. Consequently, for a given rotor position, stator segments corresponding to a common phase can be appropriately aligned with corresponding rotor poles. In the exemplar rotor position of FIG. 12, the stator segments corresponding to the first phase (Phase A) are all appropriately aligned across each of the stator modules 304.

Referring now to FIG. 13, the bus bar module 200 can be implemented with the exemplar electric machine 300, a portion of which is illustrated. In the exemplar arrangement illustrated in FIG. 13, the bus bar 204b is in electrical communication with the stator segments 306a and 306d, the bus bar 204a is in electrical communication with the stator segments 306b and 306e, and the bus bar 204c is in electrical communication with the stator segments 306c and 306f for the stator module 304. In the case of the adjacent stator module 304′, the relationship between the stator segments and the bus bars is shifted. More specifically, the bus bar 204a is in electrical communication with the stator segments 306a and 306d, the bus bar 204c is in electrical communication with the stator segments 306b and 306e, and the bus bar 204b is in electrical communication with the stator segments 306c and 306f. Although not illustrated, the relationship between the stator segments and the bus bars is again shifted for the next adjacent stator module. More specifically, the bus bar 204c is in electrical communication with the stator segments 306a and 306d, the bus bar 204b is in electrical communication with the stator segments 306b and 306e, and the bus bar 204a is in electrical communication with the stator segments 306c and 306f for the next adjacent stator module (not shown).

The previously described exemplar electric machines have all been described as including a bus bar for electrically interconnecting the stator modules of the stator assembly and for providing the phase shift function where needed. However, in another exemplar implementation, the bus bar may be eliminated by providing a separate controller for each of the stator modules.

Referring back to FIG. 12, in this implementation, each stator module 304 includes a stator housing 308. Included in each stator module 304 is a stator module controller 310 and leads 312 electrically connecting stator module controller 310 to each stator segment 306 within that stator module. Each stator module controller 310 regulates operation of the stator module 304 based on an input signal 314 and a position signal 316. The input signal 314 can include a throttle signal, for example, in the case where the electric machine 300 is implemented in a vehicle, motorcycle, scooter, or the like. Stator module 304 also includes a Hall Effect sensor or other position detecting arrangement 318 for detecting the position of the stator module relative to the rotor magnets 314. The Hall Effect sensor or other position detecting arrangement 312 generates the position signal 316 used by the stator module controller 310. The stator module controller 310 can regulate power provided to the stator module 304 from a power source 320, when the electric machine 300 is operating in a motor mode. The stator module 304 can generate power that can be provided to, and stored in the power source 320, when the electric machine 300 is operating in a generator mode. This configuration eliminates the need for a bus bar as described above and only a power connection and a signal input need to be provided to each stator module 304.

Since each stator module includes its own Hall Effect sensor or other position detection arrangement 318, each controller is able to control its associated stator segments without regard to the relative positions of the other stator modules. Therefore, controllers 310 automatically account for any phase shifting that may be caused by differences in the relative positions of the stator segments in relationship to the rotor poles.

Now that several exemplar implementations of an electric machine designed in accordance with the disclosure have been described, a few specific examples will be described to more clearly point out the advantages of this approach. In a first example, a permanent magnet, regenerative motor having the general configuration described above with reference to FIG. 12 will be described. This configuration places the radial gap out near the outer perimeter of the device which provides the largest possible torque arm for a given size device.

In this first example of a specific electric machine in accordance with the disclosure, the motor is a regenerative hub motor for an electric scooter. The hub motor has an overall diameter of about 11 inches and an overall width of about 3 inches. The regenerative motor is configured to provide space for up to six stator modules with each stator module including six stator segments. In this example, the rotor includes fifty six pairs of rotor magnets to form the rotor poles. Each stator segment includes a U-shaped core that is formed using thin film soft magnetic material having a tape width of about 0.256 inches thereby giving the U-shaped magnetic core an overall thickness of about 0.256 inches. For this example, the overall U-shaped magnetic core is approximately 2.25 inches wide and approximately 2 inches tall with each leg of the U-shaped core protruding about 1 inch from the base of the U-shaped core and a space of about 0.25 inch between the two legs of the U-shaped core. The stator segments also include stator shoes attached to the ends of the legs of the U-shaped core, or attached to each side of the ends of the legs of the U-shaped core to flare out the ends of the legs and increase the surface area of the face of the stator poles. For this example, the stator shoes are formed from iron powder. This configuration results in stator segments with two stator poles that have a stator pole face that is about 1 inch wide with a span along the direction of rotation of about 0.425 inches. In this example, coils are placed on each leg of the U-shaped core by winding fifty four turns in two layers of 15-gauge wire over each leg along the length of the legs with the second layer of turns extending up only a portion of the leg. Super magnets are used to form the rotor poles with each magnet segment being approximately 0.18 inches thick and about 1.164 inches wide with each magnet segment having a magnet span of about 0.51 inches along the direction of the rotational path of the rotor. The magnets are attached to a backiron that is about 0.150 inches thick and about 2.5 inches wide. This configuration results in an overall device that has a torque arm of about 5.25 inches. The total weight of the magnetic components making up the motor is only about 14.2 pounds. These magnetic components include the backiron, magnets, magnetic cores, and windings.

Because the device described above uses a thin film soft magnetic material to form the stator cores, this device is capable of being operated at frequencies of up to, or more than 2500 Hz, which corresponds to a rotational speed of up to or more than 5360 RPM. However, since the regenerative motor of this example is being used as a hub motor for a scooter with a wheel radius of about 17 inches, and since the scooter is designed for a top speed of about 65 mph, the controller is designed to operate the hub motor at a maximum rotation speed of about 1285 RPM. This corresponds to a maximum frequency of about 600 Hz.

As mentioned above, the motor operates in a frequency range of 0-600 Hz and rotates at speeds in the range of 0-1285 RPM. In addition, the magnetic components of the motor only weigh about 14.2 pounds. The peak torque for this electric motor is about 176 foot-pounds. Therefore, the torque density is about 12.4 foot pounds per pound if the weight of only the magnetic components making up the regenerative motor is used to calculate the torque density. As can be seen by these results, devices designed in accordance with the disclosure are capable of extremely high torque densities.

Although the example described above has been described as being an 11 inch regenerative hub motor having fifty six magnet pairs and six stator modules with each stator module including six stator segments, this is not a requirement. In fact, certain applications may utilize rotors with higher pole counts in larger diameter devices. For example, the overall diameter of the motor may be substantially larger and the number of magnets and electromagnets may be much greater. In order to illustrate this point, an additional example will be described.

In this example, the motor has an overall diameter of about 14 inches rather than the 11 inches described above. This size motor provides space for up to eight stator modules with each stator module including six stator segments when the same stator segments are used as those described above for the 11 inch motor. In this example, the rotor includes seventy two pairs of rotor magnets to form the rotor poles. Each U-shaped core piece of each stator segment is formed using thin film soft magnetic material with the same basic dimensions as described above for the previous example. This use of the same magnetic cores for motors of a variety of sizes provides the advantage of economies of scale as described above. Since the same sized magnetic cores, windings, magnets are used, and since the number of stator modules is increasing from six to eight, the weight of the magnetic components for the 14 inch version of motor increases from about 14.2 pounds to about 18.9 pounds.

By scaling up the design as described above, the larger 14-inch motor provides a peak torque of about 302 foot-pounds. Therefore, the torque density for this example is about 16 foot-pounds per pound of magnetic components making up the motor. Even larger torque densities could be provided by larger diameter motors using these same magnetic components.

A number of implementations of the present disclosure have been described. Nevertheless, it will be understood that various modifications may be made without departing from the spirit and scope of the present disclosure. For example, although the implementations described above have described the electric machine as being a radial gap machine, this is not a requirement. FIG. 14 illustrates an exemplar axial gap electric machine 400 designed in accordance with the disclosure. Accordingly, other implementations are within the scope of the following claims.

1. A rotating electric machine, comprising:
a rotor assembly supported for rotation about a rotational axis, the rotor assembly including a plurality of rotor poles, the rotor poles being supported for rotation about the rotational axis; and
a stator assembly including a plurality of independent stator modules with each stator module including multiple independently energizable stator segments, each stator segment defining a plurality of stator poles of the stator assembly for magnetically interacting with the rotor poles, each stator module being independently removable and replaceable from the stator assembly to adjust the total number of stator poles included in the stator assembly.

2. The machine of claim 1, wherein the number of rotor poles is fixed.

3. The machine of claim 1, wherein the stator assembly includes a number of receiving arrangements N, each receiving arrangement being capable of receiving a stator module.

4. The machine of claim 3, wherein the stator assembly includes less than N stator modules and wherein the stator modules are positioned symmetrically around the rotational axis.

5. The machine of claim 3, wherein the stator assembly includes less than N stator modules and wherein the stator modules are positioned asymmetrically around the rotational axis.

6. The machine of claim 1, wherein each stator module includes a stator module housing for supporting the multiple stator segments of the stator module in predetermined positions within the stator module housing.

7. The machine of claim 6, wherein the stator module housing and the stator assembly include an indexing arrangement for controlling the position of the stator module relative to the stator assembly when the stator module is attached to the stator assembly.

8. The machine of claim 1, wherein each stator module includes a controller for controlling the energizing of the stator segments of each stator module.

9. The machine of claim 1, wherein the machine further includes:
a switching arrangement for controlling the stator segments, the switching arrangement being configured such that the switching arrangement is able to cause the stator poles of the stator segments to magnetically interact with the rotor poles at a frequency of at least 400 cycles per second.

10. The machine of claim 1, wherein the electric machine is a multiple phase electric machine.

11. The machine of claim 10, wherein each stator module includes at least one stator segment associated with each phase of the electric machine.

12. The machine of claim 11, wherein the machine is a three-phase machine and wherein each stator module includes at least two stator segments for each phase, the stator module thereby including at least six stator segments.

13. The machine of claim 12, wherein the stator assembly includes at least six receiving arrangements for receiving up to at least six stator modules.

14. The machine of claim 1, wherein each stator segment includes a U-shaped magnetic core, wherein each stator segment defines two stator poles located at opposite ends of the U-shaped magnetic core, and wherein the U-shaped magnetic core provides the entire magnetic return path for the two stator poles associated with each stator segment.

15. The machine of to claim 14, wherein the magnetic core of each stator segment is formed from thin film soft magnetic material.

16. The machine of claim 15, wherein the thin film soft magnetic material is a nano-crystalline material.

17. The machine of claim 15, wherein the thin film soft magnetic material is an amorphous metal material.

18. The machine of claim 1, wherein the stator assembly is disposed radially adjacent to the rotor assembly such that the stator assembly and the rotor assembly define therebetween an active magnetic radial gap.

19. The machine of claim 1, wherein the stator assembly is disposed axially adjacent to the rotor assembly such that the stator assembly and the rotor assembly define therebetween an active magnetic axial gap.

20. The machine of claim 18, wherein:
each stator segment includes a U-shaped magnetic core formed by a plurality of concentric U-shaped layers of thin film soft magnetic material with each stator segment defining two stator poles located at opposite ends of the U-shaped magnetic core and with each stator segment being positioned such that the two stator poles of each stator segment are located adjacent to one another and in line with one another along a line that is parallel with the rotational axis of the electric machine and each layer of the thin film soft magnetic material is oriented parallel with the direction of rotation of the rotor assembly; and
the rotor poles are pairs of rotor poles formed from adjacent pairs of permanent magnet segments configured to form rotor poles of opposite magnetic polarity, each pair of permanent magnet segments being positioned such that the two permanent magnet segments are located adjacent to one another and in line with one another along a line that is parallel with the rotational axis of the electric machine such that the two permanent magnet segments define two adjacent circular paths around the rotational axis of the electric machine when the rotor is rotated about the rotational axis of the electric machine, each of the two adjacent circular paths facing an associated one of the stator poles of each independently energizable stator segment.

21. A stator module for use in a rotating electric machine including a stator assembly having a plurality of stator poles and a rotor assembly supported for rotation relative to the stator assembly about a rotational axis, the rotor assembly including a plurality of rotor poles for magnetically interacting with the stator poles, the stator module comprising:
multiple independently energizable stator segments with each stator segment defining a plurality of stator poles of the stator assembly, the stator module being configured to be supported in the stator assembly such that the stator module and its associated stator poles are independently removable and replaceable from the stator assembly to adjust the total number of stator poles included in the stator assembly.

22. A stator assembly for an electric machine, the stator assembly comprising:
a plurality of independent stator modules, each stator module including multiple independently energizable stator segments, each stator segment defining a plurality of stator poles of the stator assembly for magnetically interacting with rotor poles of the electric machine, each stator module being independently removable and replaceable from the stator assembly to adjust the total number of stator poles included in the stator assembly.

23. A rotating electric machine, comprising:
a rotor assembly supported for rotation about a rotational axis, the rotor assembly including a plurality of rotor poles, the rotor poles being supported for rotation about the rotational axis; and
a stator assembly including a plurality of independent stator modules with each stator module including multiple independently energizable stator segments, each stator segment defining a plurality of stator poles of the stator assembly for magnetically interacting with the rotor poles, each stator module being independently removable and replaceable from the stator assembly to vary the maximum power output of the electric machine.

24. The machine of claim 23, wherein the number of rotor poles is fixed.

25. The machine of claim 23, wherein the stator assembly includes a number of receiving arrangements N, each receiving arrangement being capable of receiving a stator module.

26. The machine of claim 25, wherein the stator assembly includes less than N stator modules and wherein the stator modules are positioned symmetrically around the rotational axis.

27. The machine of claim 25, wherein the stator assembly includes less than N stator modules and wherein the stator modules are positioned asymmetrically around the rotational axis.

28. The machine of claim 23, wherein each stator module includes a stator module housing for supporting the multiple stator segments of the stator module in predetermined positions within the stator module housing.

29. The machine of claim 28, wherein the stator module housing and the stator assembly include an indexing arrangement for controlling the position of the stator module relative to the stator assembly when the stator module is attached to the stator assembly.

30. The machine of claim 23, wherein each stator module includes a controller for controlling the energizing of the stator segments of each stator module.

31. The machine of claim 23 one or more of the preceding claims, wherein the machine further includes:
a switching arrangement for controlling the stator segments, the switching arrangement being configured such that the switching arrangement is able to cause the stator poles of the stator segments to magnetically interact with the rotor poles at a frequency of at least 400 cycles per second.

32. The machine of claim 23, wherein the electric machine is a multiple phase electric machine.

33. The machine of claim 32, wherein each stator module includes at least one stator segment associated with each phase of the electric machine.

34. The machine of claim 33, wherein the machine is a three-phase machine and wherein each stator module includes at least two stator segments for each phase, the stator module thereby including at least six stator segments.

35. The machine of claim 34, wherein the stator assembly includes at least six receiving arrangements for receiving up to at least six stator modules.

36. The machine of claim 23, wherein each stator segment includes a U-shaped magnetic core, wherein each stator segment defines two stator poles located at opposite ends of the U-shaped magnetic core, and wherein the U-shaped magnetic core provides the entire magnetic return path for the two stator poles associated with each stator segment.

37. The machine of to claim 36, wherein the magnetic core of each stator segment is formed from thin film soft magnetic material.

38. The machine of claim 37, wherein the thin film soft magnetic material is a nano-crystalline material.

39. The machine of claim 37, wherein the thin film soft magnetic material is an amorphous metal material.

40. The machine of claim 23, wherein the stator assembly is disposed radially adjacent to the rotor assembly such that the stator assembly and the rotor assembly define therebetween an active magnetic radial gap.

41. The machine of claim 23, wherein the stator assembly is disposed axially adjacent to the rotor assembly such that the stator assembly and the rotor assembly define therebetween an active magnetic axial gap.

42. The machine of claim 40, wherein:
each stator segment is positioned such that the two stator poles of each stator segment are located adjacent to one another and in line with one another along a line that is parallel with the rotational axis of the electric machine; and
the rotor poles are pairs of rotor poles formed from adjacent pairs of permanent magnet segments configured to form rotor poles of opposite magnetic polarity, each pair of permanent magnet segments being positioned such that the two permanent magnet segments are located adjacent to one another and in line with one another along a line that is parallel with the rotational axis of the electric machine such that the two permanent magnet segments define two adjacent circular paths around the rotational axis of the electric machine when the rotor is rotated about the rotational axis of the electric machine, each of the two adjacent circular paths facing an associated one of the stator poles of each independently energizable stator segment.

43. A rotating electric machine, comprising:
a rotor assembly supported for rotation about a rotational axis, the rotor assembly including a plurality of rotor poles, the rotor poles being supported for rotation about the rotational axis;
a stator assembly including a plurality of independent stator modules with each stator module including multiple independently energizable stator segments, each stator segment defining a plurality of stator poles of the stator assembly for magnetically interacting with the rotor poles, each stator module being independently removable and replaceable from the stator assembly to adjust the total number of stator poles included in the stator assembly; and
a switching arrangement for controlling the stator segments, the switching arrangement being configured such that the switching arrangement is able to cause the stator poles of the stator segments to magnetically interact with the rotor poles at a frequency of at least 400 cycles per second.

44. The machine of claim 43, wherein the switching arrangement is configured such that the switching arrangement is able to cause the stator poles of the stator segments to magnetically interact with the rotor poles at a frequency of up to 2500 cycles per second.
